(19) United States
(12) Patent Application Publication
(10) Pub. No.: US 2017/0208072 A1
(43) Pub. Date: Jul. 20, 2017

(54) Controlling Permissions in a Communication System

(71) Applicant: Microsoft Technology Licensing, LLC, Redmond, WA (US)

(72) Inventors: Felicity S. Herst, London (GB); Martin Chapman, Kent (GB)

(21) Appl. No.: 15/066,188

(22) Filed: Mar. 10, 2016

(30) Foreign Application Priority Data
Jan. 15, 2016 (GB) 1600807.0

(51) Int. Cl. H04L 29/06

(52) U.S. Cl. CPC H04L 63/102; H04L 63/101

(57) ABSTRACT

A communication system maintains a list of contacts of a first user, being other users who have been accepted by the first user as contacts, and who are thereby granted one or more permissions in relation to communicating with the first user via the communication system, these being permissions not being granted to any of said other users who are not contacts. At the first user's terminal, a conversation area is presented in the UI, including a messaging field allowing the first user to send content as part of a two-way conversation. According to the present disclosure, when the first user receives a contact request from a second user who is not yet a contact, the contact request comprises a message to the first user. Further, if the first user replies to this message through the messaging field in the conversation area, the contact request is automatically accepted.

### RELATED APPLICATIONS

This application claims priority under 35 U.S.C. §120 to G.B. Patent Application No. 1600807.0 entitled “Controlling Permissions in a Communication System,” filed Jan. 15, 2016, the disclosure of which is contained herein in its entirety by reference.

### BACKGROUND

Various technologies exist which enable users to conduct communications over a computer network, whether the network in question is the Internet or another type of network such as a company intranet. These technologies include instant messaging (IM), voice calls such as voice-over Internet Protocol (VoIP) calls, video calls, sharing still images (picture messaging), sharing video clips (video messaging), and sharing one's geographic location.

The personal security of users is an issue, and therefore such communication systems often work based on the principle of contacts. This means that the system maintains a contact list for each user, typically on a server (where a server herein may refer to a logical server comprising one or more server units located at one or more geographical sites). The contact list is a list of other users of the communication system whom the user in question has accepted as contacts. Contacts and non-contacts are granted different permissions. Particularly, the way in which other users can communicate with a given user, and the information they can view about that user, is limited until accepted as contact.

For example, as a default setting, other users may be allowed to send a call request to initiate a voice or video call but cannot send IM messages to a given user until that user has accepted the other user as a contact. Other restrictions may also apply. E.g. the user's presence state, geographic location, status message (sometimes also called a “mood message”) and certain information from the user's profile may not be made available to other users until they have been accepted as a contact. In some cases these permissions can be changed via user settings.

To send a contact request, the requesting user searches for the desired recipient user using a search tool of the communication system, and then assuming the user in question is found, the requesting user selects to send a contact request to the recipient. When the contact request is received by the recipient user, this user is presented with buttons providing explicit options as to what to do with the contact request, e.g. accept, block or ignore.

### SUMMARY

It is also desirable to try to maximize the number of potential connections that can be established between users in a network in order to increase the utility of the system. However, the contacts-based model in fact restricts the set of available connections between users. There is therefore a conflict: on the one hand the users' security needs to be preserved, but on the other hand it is desirable to try to maximise the utility of the system in terms of interconnectivity between users. It is identified herein that while the contacts-based model should be retained for security purposes, and while to some extent a contact-based system will always impose some restriction in terms of connectivity, there is nonetheless scope to facilitate the building of a more complete graph of available connections by removing barriers to users accepting one another as contacts.

Particularly, contact requests are often passively ignored (as opposed to the receiving user explicitly selecting to ignore the request), even though the receiving user may in fact know the user sending the contact request, and sometimes may even have communicated with that user over the system via one of the non-restricted modes of communication (e.g. VoIP call). The present disclosure provides a system which preserves the contact model, but provides a more fluid mechanism for forming contacts and thereby augmenting the total connectedness of the system.

According to one aspect disclosed herein, there is provided a method comprising, from a first user terminal, a first user accessing a communication system for communicating with a plurality of other users of other user terminals via a network, wherein the communication system maintains a list of contacts of the first user, the contacts being ones of the other users who have been accepted by the first user as contacts. The contacts are thereby granted one or more permissions in relation to communicating with the first user via the communication system, said one or more permissions not being granted to any of said other users who are not amongst the contacts. In a conversation area of a user interface on the first terminal, there is provided a messaging field in which the first user can enter content (e.g. IM messages, pictures, video clips, etc.) to be communicated to selected ones of the other users as part of two-way conversation conducted via said communication system. The method further comprises, at the first user terminal, receiving a contact request from a second user of a second user terminal, the second user being one of the other users who is not yet one of the contacts of the first user, and the contact request requesting that the second user becomes one of said contacts. Furthermore, according to the present disclosure, the contact request is automatically accepted, thereby accepting the second user as one of said contacts of the first user, in response to the user replying to said message through the messaging field.

Thus when the first user interacts with the second user, this is taken as an implicit acceptance of the second user as a contact. Advantageously this breaks down a barrier to forming connections between users, whilst at the same time retaining the contact-based model.

For example, the message received in the contact request may be displayed in the conversation pane almost as if it was any other IM message, and if the first user replies with an IM message entered through the IM field (the same field that is used for IM conversations generally) then the system infers that the second user is known by the first user and therefore can be added as a contact. In embodiments, the first user could also cause the second user to be accepted by reply with other types of message such as a picture message, video message or shared location.

According to another aspect disclosed herein, there is provided a computer program product embodied on computer-readable storage and configured so as when run on one or more processors to cause the disclosed method to be performed. The computer-program product may take the form of a client application for running on the first user terminal. Alternatively the computer-program product may take the form of a web client for being hosted on a server, to be accessed by the first terminal via the internet.

According to another aspect disclosed herein, there is provided a network element configured to perform the method according to any of the embodiments disclosed herein. The network element may be the first user terminal, or may be a server (comprising one or more server units at one or more geographical sites).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic illustration of a communication system,

FIG. 2 is a schematic mock-up of a user interface of a client application, and

FIG. 3 is another schematic mock-up of a user interface of a client application.

### DETAILED DESCRIPTION OF EMBODIMENTS

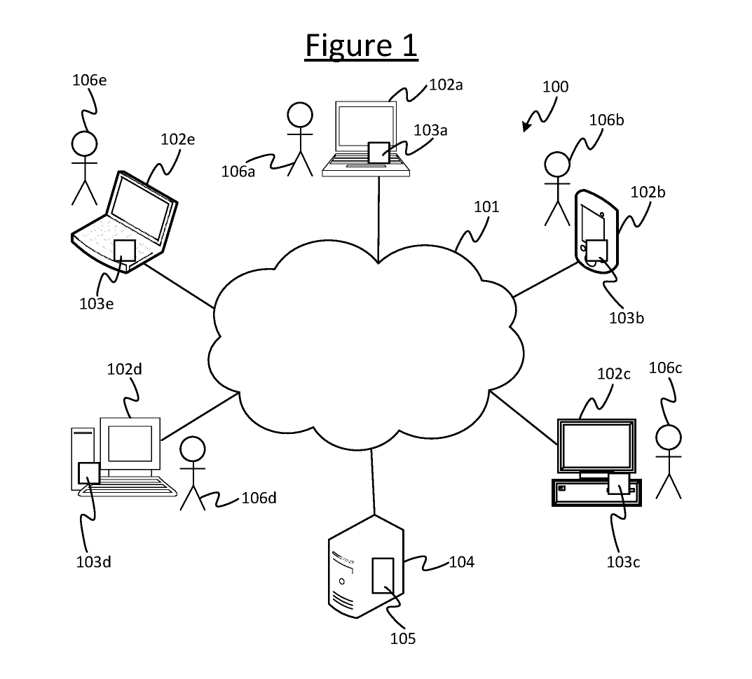

FIG. 1 schematically illustrates a communication system 100 in accordance with embodiments disclosed herein. The communication system comprises a plurality of user terminals 102 each configured to be connect to a computer network 101, and each installed with a respective instance of a communication client application 103. Each of the user terminals 102 is also used by at least one respective user 106. In FIG. 1, five user terminals 102a-e and their respective clients 103a-e and users 106a-e are shown for illustrative purposes, but it will be appreciated that there may be different numbers of user terminals 102 involved in other scenarios covered by the present disclosure. The network 101 is preferably a packet-based network. In embodiments it may take the form of a wide-area internetwork such as that commonly referred to as the Internet. Alternatively the network 101 may take the form of another type of network such as a company intranet, a mobile cellular network, or a wireless local area network (WLAN), or a combination of any of these and/or the Internet.

Each of the user terminals 102 may take any of a variety of different forms, such as a desktop computer, laptop, tablet, smartphone, smart watch, pair of smart glasses, smart TV, set-top box, or conference room phone unit (and the different user terminals 102 need not necessarily take the same form as one another). Note therefore that the term “computer” as used herein does not restrict to a traditional desktop or laptop computer.

The communication clients 103 are each installed on computer-readable storage of their respective user terminal 102, and arranged for execution on a respective processing apparatus of the respective user terminal 102. The storage may take the form of one or more storage media (e.g. magnetic memory, electronic memory or optical memory) implemented in one or more memory units. The processing apparatus may take the form of one or more processing units. Each of the communications clients 103 is configured so as to be able to establish a communication session with one or more others of the communication clients 103 running on one or more of the other respective user terminals 102. The user of each user terminal 102 is then able to send messages to each other of the users of each other of the user terminals 102 participating in the session. In embodiments, the messages may include any one or more “traditional” types of message such as: IM messages, live voice (e.g. VoIP) streams (of the sending user's voice), and/or live video streams (e.g. a head-and-shoulders shot of the sending user). Alternatively or additionally, the messages may include one or more other types of message such as: still images (picture messaging), pre-recorded video clips (video messaging), pre-recorded audio clips (e.g. voice mail), a shared geographical location (e.g. as detected by a localization system such as GPS), screen sharing streams, remote slide representations, and/or electronic or virtual whiteboard streams.

In embodiments the communication system 101 comprises a server 104 connected to the network 101, arranged to provide a communication service via which the communication session is at least in part conducted. In such embodiments, the message from any given one of the users is sent from the sending user terminal, e.g. 102a, to the server 104, and the server 104 is configured to forward the message on to each of the recipient user terminals 102b-e. Alternatively however, the messages may be sent based on a peer-to-peer (P2P) topology, in which case the server 104 is not needed for the purpose of forwarding the messages to their destination.

Note also, in yet further embodiments, the system need not comprise a communication client 103 installed on each user terminal 102. For instance, alternatively one, some or all of the user terminals could instead be installed with a general purpose web browser operable to access a web-based version of the client application (“web client”) hosted on the server 104. In such cases the described functionality may be achieved by the web-client rather than the locally installed client (i.e. client installed locally on an individual user terminal 102). Or more generally, the functionality disclosed herein can be implemented by any combination of a local client application 103 (on each user terminal 102) and/or server hosted functionality (e.g. a web client). For conciseness the various options in this respect will not be repeated each time the functionality below is described, but it will be understood that these options apply throughout.

Regardless of whether the messages are sent via the server 104 or whether they are sent peer-to-peer, and regardless of whether a local clients is installed on each user terminal 102 or whether a server-hosted client is used, the server 104 may also be arranged to provide additional functionality in association with the communication service. Particularly, the server 104 maintains a contact a list 105 for each of the users 106. The contact list 105 for a given user is a list of the other users which that user has accepted as contacts. This will be discussed in more detail shortly. Note: it is not essential to store the contact lists centrally at a server 104. Instead the contact list for a given user could be stored on the user's own user terminal 102. However, that would mean the contact list was not necessarily available to that user when he or she logged on from a different device 102. As another alternative, the contact list could be stored in a distributed P2P database. However, users may not be comfortable having their personal details stored in this manner.

The server 104 may optionally also keep additional, supplementary information for each of the users 106, such as a respective user profile, a respective status message, a respective presence status, and/or respective location information. This supplementary information is made available from the server 104 via the network 101 to at least some others of the users 106b-e. In embodiments, some or all of this information may only be able available to any other users of the service whom the user in question has accepted as a contact.

The information in each user's profile may comprise for example any one or more of: an email address of the respective user, a profile picture of the respective user, a place of residence of the respective user, and/or a time zone or local time of the respective user, etc.

The respective profile information for a given user is typically set by that user him- or herself, via the respective client application 103 which sends it to be stored at the server 104.

The status message is sometimes also referred to as a “mood message”. It is a brief statement composed by the respective user him- or herself as to his or her current state of being, e.g. “Feeling good as the sun is out today” or “OOO, back in Monday 25^{th} January”.

The presence status indicates the user's availability for communication within the communication system, e.g. selected from a set comprising two or more of: do not disturb (DND), offline, inactive or available. In embodiments the presence status is determined at least partially automatically, e.g. by detecting when the user is not logged in and is therefore offline, and/or by detecting that if the user has not interacted with his or her user terminal 102 (e.g. has not moved the mouse) then he or she is inactive. DND is typically set manually by the respective user. The available state may be determined automatically if the user is neither offline nor inactive and has not selected DND. Some of the possible presence states may be detected by the client application 103 and reported to the server 104, e.g. whether the user is inactive. Other possible states may be detected directly by the server 104, e.g. whether the user is offline. Some possible states may be detected by either client 103 or server 104, e.g. whether the user has selected DND, and/or whether he or she is available.

The location information may be set manually by the respective user 106, but in embodiments it is detected automatically based on one or more location technologies, e.g. a satellite-based location technology such as GPS or Galileo, or by reference to other wireless nodes such as cell towers of a mobile communication system, anchor nodes of an indoor positioning system, or Wi-Fi hotspots, etc. The client 103 detects the location of the respective user terminal 102 and reports this to the server 104.

Note: with regard to this supplementary information (e.g. profile information, status message, presence state and/or location information), it is not essential to store this centrally at a server 104. However similar considerations as discussed in relation to the contact list 105 may apply. I.e. the information could be stored on the user's own user terminal 102, but that would mean it was not necessarily available to that user when he or she logged on from a different device 102; or the information could be stored in a distributed P2P database, but users may not be comfortable having their personal details stored in this manner.

The contact list 105 for a given user records which of the other users of the communication system that user has accepted as contacts. This in turn determines what permissions the other users are granted in relation to communicating with the user via the communication system, in dependence on whether they are each a contact or not. By way of illustration the following will be described from the perspective of a contact list 105 of a first user 106a of a first user terminal 102a, where the first user 106a is receiving a contact request from a second user 106b of a second user terminal 102b, but it will be appreciated that similar teachings can apply in relation to any combination of users.

There are at least two possible categories of permissions that the contact list determines. The first category defines the type of communication the second user 106b can establish with the first user 106a, or indeed whether or not the second user 106b can communicate with the first user 106a at all (at least via the communication system in question). For example, in embodiments the second user 106b is allowed to send a call establishment request to start a voice or video call (e.g. VoIP call) with the first user 106a without the second user 106a having been accepted as a contact of the first user 102a. This means the client 103a on the first user's terminal 102a will cause it to “ring” to alert the first user 106a to an incoming call, which the first user 106a can answer in the same way he or she would for a contact. However, in embodiments, the second user 106b cannot send other types of communication to the first user 106a without having first been accepted as a contact of the first user 106a. For example, the second user 106b may not be allowed to send IM messages, picture messages, video messages, voice mail and/or a shared location to the first user 106a until he or she is accepted as a contact of the first user 106a. In general, any combination of allowed and not-allowed communication types may be enforced for non-contacts.

As mentioned, the system may also store supplementary information such as a respective user profile, status message, presence status and/or location information in relation to the first user 106a. This supplementary information relates to the communication with the first user 106a via the communication system in that it is accessed via the same communication system and provides information that supplements the experience of communicating with the first user 106a. For instance, the presence state indicates whether the user is available to be communicated with; and the user profile, status message and/or location add context to the communication with the first user 106a (e.g. the experience of communicating with the first user 106a may be shaped or informed by knowing personal information about the user, or knowing that he or she is having a bad day, or that he or she is currently in a certain town or country).

The second category of permissions therefore defines what supplementary information of the first user 106a can be viewed by the second user 106b via the communication system. For instance, in embodiments the second user 106b is not allowed to view the first user's status message, presence nor location until the second user 106b has been accepted as a contact of the first user 106a. In embodiments, the second user 106b may be allowed to view certain selected parts of the first user's profile information via the communication system without having been accepted as a contact of the first user 106a, while other parts of the profile information may remain unavailable until accepted as a contact. In general, any combination of viewable and not-viewable supplementary information may be enforced for non-contacts.

In some embodiments, the permissions for the first user's contacts and non-contacts may be defined at least in part by a set of user preferences (i.e. settings) which can be set by the first user 106a him- or herself. These settings may be stored at the server 104 or locally on the user's own respective user terminal 102a (wherein similar considerations as to server-based or non-server-based storage location may apply as discussed in relation to the contact list and supplementary information such use user profile). Thus there are maintained a first set of permissions for the contacts and a second set of permissions for non-contacts (where the second set may be a subset of the first, or may overlap with the first), wherein one or more of these permissions can be set by the first user 106a as a user preference. These settable permissions may comprise one or more permissions in the first category, i.e. which communication types are not allowed for non-contacts, and/or one or more permissions in the second category, i.e. which types of supplementary information is visible to non-contacts (e.g. profile information, presence, etc.).

In embodiments, some of the preferences may have default settings which are in place when the first user's client application 103a is first installed on the first user terminal 102a, or when the first user 106a first registers with the communication system, but which the first user 106a can later override. E.g. default settings may be that non-contacts can make voice and video calls to the first user 106a but cannot send IM messages, picture messages, video messages or leave voice mail. Any combination of defaults in general is possible.

The present disclosure uses a contacts-based model such as that described above in order to prevent the system becoming open to abuse, but at the same time provides a more fluid mechanism for accepting contacts so as to increase to the number of available connections between users.

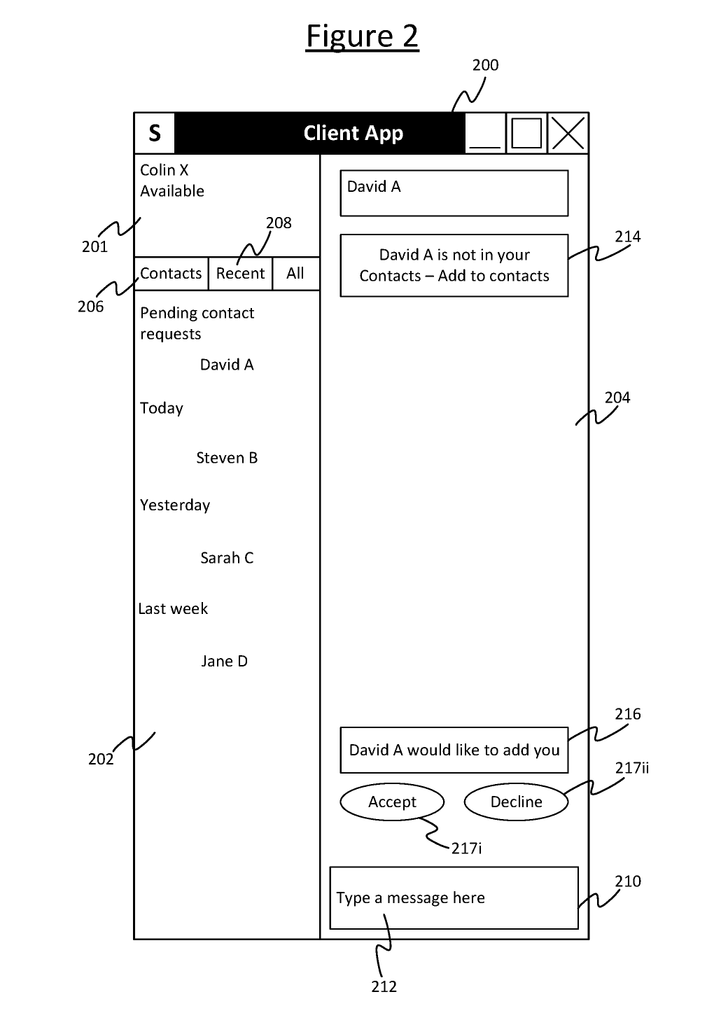

By way of comparison, an existing mechanism is first described in relation to FIG. 2. This shows the front-end user interface (UI) 200 of the client application 103a running on the first user's terminal 102a (or of the web client accessed from the first user's terminal 102a). The UI 200 comprises a plurality of UI areas such as a local user pane 201, a history pane 202 and a conversation pane 204. The local user pane 201 shows information about the first user 106a (the user of the terminal 102a on which the UI is displayed), e.g. his or her name, username, profile picture and/or presence state. The history pane 202 shows a list of conversations and contact requests that the first user 106a has been involved in or received over a certain time-window into the past. The conversation pane 204 shows the conversation or contact request that is currently selected in the history pane 202. The UI 200 may also comprise a user-operable contacts control 206 (e.g. a tab or button) and a user-operable history control 208 (e.g. again a tab or button). Actuating (e.g. clicking or touching) the contacts control 206 brings up a list 105 of the first user's contacts from which he or she can select to establish communications with those contacts. Actuating (e.g. clicking or touching) the history control 208 brings up the history pane 202. In the arrangement shown the contacts list pane would be displayed in place of the history pane 202 when the contacts control 206 is actuated, and vice versa, but this need not necessarily be the case.

The conversation pane 204 is where the first user actually conducts two-way conversations with other users (via the communication system in question). When another user sends a message to the first user 106a, it appears in the conversation pane 204. Also, the conversation pane 204 comprises a messaging field 210 in which the first user can enter messages to be sent to the user(s) 106 on the other end of the conversation. In the example shown, the conversation pane 204 comprises a note 212 to the first user 106a inviting him or her to type an IM message (a type of text based message) into the message field 210, thereby enabling the user to conduct an IM conversation with the other users. E.g. this may be displayed in the messaging field 210, perhaps greyed out. However, note that the term “conversation” as used herein does not limit as to the type of messages being exchanged. For example, the messages exchanged as part of the conversation may comprise any one or more of: text-based messages (e.g. IM messages), live voice and/or video streams (voice and/or video calls), still images (picture messages), pre-recorded audio clips (voice mail), pre-recorded video clips (video messages), a shared location, a slide show, a screen-share, content from an electronic or virtual whiteboard, or any combination of such message types. E.g. the first user 106a can paste in or drag and drop video clips into the messaging field 210 and the clip will be send over the network 101 to the user(s) on the other end. Any such exchanges may be referred to herein as a “conversation”.

When the first user terminal 102a receives a contact request from the second user 106b, some dedicated UI elements are presented to the first user 106a in the conversation pane 204. These include a notification 214, 216 to the first user 106a that the second user 106b is requesting to become a contact (the notification identifying the second user 106b, e.g. by real-life name or username); and also two or more explicit, user-selectable options 217i, 217ii as to what to do about the request. These explicit options includes at least an accept option 217i which and one or more other, negative options 217ii, where there one or more other options may comprise one or more of: decline, ignore, bock, and/or report as spam. E.g. these options 217i, 217ii may take the form of on-screen buttons. The first user 106a must therefore make an active decision as to whether to include the second user 106b amongst his or her contacts in the contact list 105. If the first user 106b does nothing, the second user 106b is never added as a contact and the contact request remains as a permanent or at least long-term item in the first user's history.

However, while the contacts model is beneficial for security, it is identified herein that the particular mechanism described above also acts to unduly restrict the number of available connections between users, therefore inhibiting the utility of the system in terms of the volume of communications that are conducted and the number of combinations of endpoints between which those communications are conducted. Particularly, it has been identified that many contact requests are simply passively ignored be the receiving user 106a (rather than actively selecting an ignore option), even though that user might in fact know the requesting user 106b, and/or may even have gone on to communicate with him or her without accepting the contact request by instead using only one of the modes of communication allowed to non-contacts (e.g. a VoIP call).

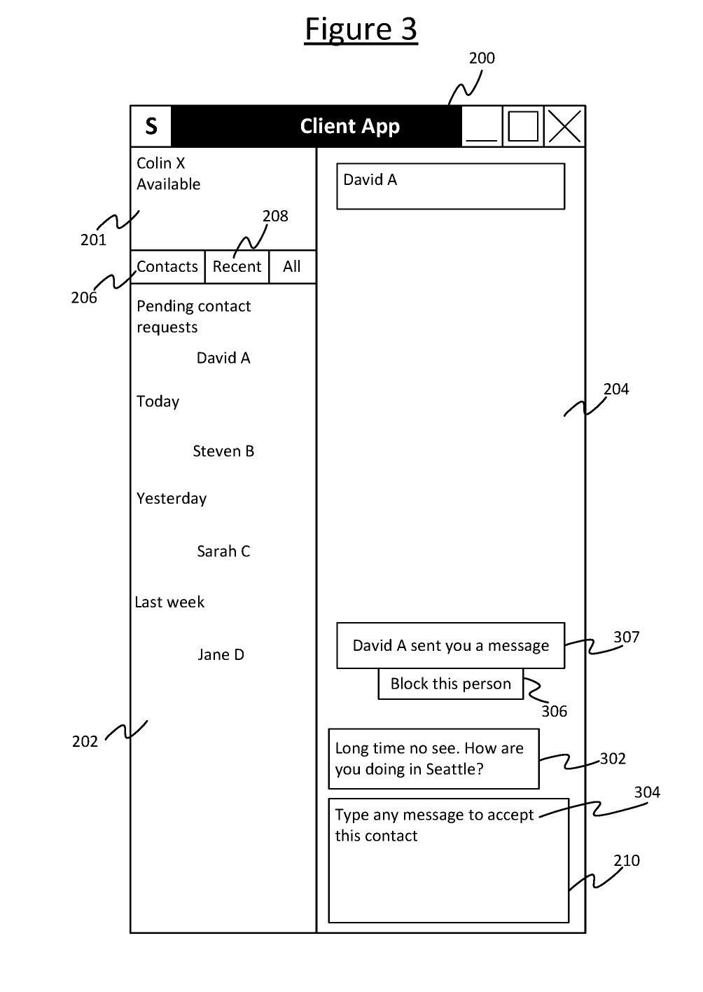

FIG. 3 illustrates a more “frictionless” mechanism in accordance with embodiments of the present disclosure. Elements in FIG. 3 are similar to those shown in FIG. 2 unless explained otherwise.

As shown in FIG. 3, the payload of the contact request received from the second user 106b contains a message 302 composed by the second user 106b. This message 302 is displayed to the first user 106a in the conversation pane 204. A notification 307 may also be displayed in the conversation window, but simply telling the user that the second user 106b sent them a message, rather than explicitly alerting the first user 106a to the fact that acceptance of a contact request is required. Further, there need not be any buttons or other such dedicated controls 217i, 217ii asking the first user to explicitly accept or not-accept the contact request. Instead, the first user 106a can implicitly accept the contact request by simply replying to the second user's message 302 with another message entered through the messaging field 210 of the conversation pane 204, just as if this was any other exchange of messages in a conversation between users who have already accepted one another as contacts. The client application 103 or server 104 automatically detects that the first user 106a has replied to the second user 106b via the messaging field 210 on the first user's terminal 102a, and based thereon infers that the first user 106a is willing to communicate with the second user 106a and therefore to accept him or her as a contact. I.e. the act of the first user 106a interacting with the second user 106b is taken as tacit acceptance of the second user 106b as a contact. Thus in response to the reply sent by the first user 106a to the message 302 received in the second user's contact request, the second user 106b is automatically added to the first user's contact list 105—i.e. without separate user interaction by the first user 106c dedicated to the act of accepting the second user 106b as a contact.

A note 304 to the first user 106a may also be displayed in the conversation pane 204 informing the first user 106a that replying to the message 302 will be taken as implicit approval of the second user 106b as a contact. E.g. this may be displayed in the messaging field 210, perhaps greyed out.

In embodiments, any interaction at all with the second user 106b is automatically taken as implicit acceptance of the contact request.

Alternatively, the client application 103 or server 104 (or a combination of them) may be configured to automatically process the actual content of the reply sent by the first user 106a through the messaging field 210, and based thereon make a decision as to whether the reply amounts to an acceptance. For example, the client 103 or sever 104 may be configured to recognize the presence of one or more of a set of predetermined negative words or phrases in the first user's reply, e.g. “Buzz off” or “Who are you?”, and in response to detecting any of these the second user 106b would not be automatically added as a contact (or even automatically blocked or reported as spam for certain subset of words or phrases). And/or, the client 103 or sever 104 may be configured to recognize the presence of one or more of a set of predetermined positive words or phrases in the first user's reply, e.g. “Nice to hear from you”, and in response to detecting any of these the second user 106b would be automatically added as a contact.

As another possibility, the client 103 or sever 104 may be configured to apply natural language processing techniques to the first user's reply, to try to extract the substantive meaning of the reply rather than relying on (or only on) the detection of predetermined phrases. The second user 106b may then be automatically added or not added depending on whether the extracted meaning is positive or negative (and in embodiments may even be blocked or reported as spam in dependence on the extracted meaning).

If on the other hand the first user 106a takes no action, the contact request is ignored.

Note also, in embodiments, the reply by the first user 106a does not have to be an IM message. In embodiments a reply in the form of any of a set of possible message types submitted through the messaging field 210 may implicitly cause an automatic acceptance, where said set may comprise any one, some or all of: an IM message or other text-based message, a voice or video call (e.g. VoIP call), a pre-recorded video clip (video message), a still image (picture message), a pre-receded audio clip (e.g. voice mail), a shared location of the first user 106c (e.g. from a satellite based positioning system or indoor location system), a slide show, a screen share, and/or content from an electronic or virtual whiteboard.

In embodiments, a block option 306 and/or report as spam option, may be floated in the conversation pane 204 (e.g. a button or hypertext). If the first user 106b actuates the block option 306 then the second user 106b will be prevented from sending any more contact requests and any other attempts at communication (e.g. requesting a VoIP call), or at least such attempts and requests will not be displayed to the first user 106b if made. If the first user 106a actuates the report as spam option, then not only is the second user 106b blocked as discussed above, but a complaint is also triggered to be logged at the server 104, where such complaints from multiple users 106 can be analysed in order to identify and remove from the system serial spammers.

Note however that even in the case where a block option 306 or report as spam option is displayed in the conversation pane 204, the first user 106a is still not prompted with an explicit positive user-operable control 217i separate to the messaging field 210 as in FIG. 2. I.e. it still does not use an explicit accept/decline or accept/ignore paradigm, or the like, as in the conventional case of FIG. 2.

In embodiments, as another alternative or additional precaution against abuse, restrictions are placed on the message 302 in the contact request compared to messages that can be exchanged between already-accepted contacts. E.g. the message 302 may be restricted to only contain text, and not any “rich content” (e.g. no audio, images nor video; no files; no software; and/or no links). And/or, the message length may be restricted compared to normal messages between contacts. E.g. the message 302 may be restricted to a certain predetermined maximum number of characters, such as two-hundred; whereas an IM message sent in a conversation between contacts may have a higher limit, e.g. 1000 characters, or may have no limit at all. And/or, the number of times a contact request can be sent may be limited to a certain predefined maximum number, e.g. five, whereas no restriction may be placed on the number of IMs that can be sent between contacts (or at least a much higher limit).

In yet further embodiments, the second user 106b has a similar UI 200 displayed on his or her user terminal 102b at the side sending the contact request. In such embodiments, optionally the second user 106b may be enabled to send a contact request by entering a message to send to the first user 106a through the message field 210 (e.g. having found the first user 106a through search tool or an auto-recommendation feature). I.e. the sending user 106b does not have to explicitly select a send contact request option through the UI 200, but rather the experience of sending a contact request is made to feel just like sending a normal IM message. Again this makes for a much more frictionless mechanism for connecting users whilst retaining the contacts-based security model.

Note however that in embodiments, although the contact request 302 can contain a message 302 in its payload, the contact request is still a separate, pre-existing mechanism of the communication system, separate from the IM messages exchanged between existing contacts. That is, the mechanism disclosed above re-uses a pre-existing contact request format of the communication system, which has a smaller payload and a different message type ID than an IM message (and indeed in embodiments, a different message type ID than any other type of message designed for sending user content between existing contacts).

It will be appreciated that the above embodiments have been described by way of example only.

More generally, according to one aspect disclosed herein there is provided a method comprising: from a first user terminal, a first user accessing a communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system, said one or more permissions not being granted to any of said other users who are not amongst the contacts; in a conversation area of a user interface on the first terminal, providing a messaging field in which the first user can enter content to be communicated to selected ones of the other users as part of two-way conversations conducted via said communication system; at the first user terminal, receiving a contact request from a second user of a second user terminal, the second user being one of the other users who is not yet one of the contacts of the first user, and the contact request requesting that the second user becomes one of said contacts; and automatically accepting the contact request, thereby accepting the second user as one of said contacts of the first user, in response to the user replying to said message through the messaging field.

In embodiments, the contact request may comprise a message from the second user that is displayed in the conversation area in association with said messaging field.

In embodiments, the number of contact requests the second user can send may be limited to a predetermined number of requests.

In embodiments, said one or more permissions may comprise an ability to send IM messages to the first user via the communication system. E.g. the message in the contact request may be limited to a first predetermined length whilst the IM messages may be limited to a second predetermined length longer than the first predetermined length, or whilst the IM messages may not be limited in length.

In embodiments, the message sent in the contact request may not be allowed to contain media other than text, whilst communications received by the first user terminal via said communication system from the contacts of the first user may contain media other than text.

In embodiments, said one or more permissions may comprise permission to initiate a voice call with the first user via the communication system.

In embodiments, said one or more permissions may comprise permission to initiate a video call with the first user via the communication system

In embodiments, said one or more permissions may comprise permission to view a presence status of the first user via the communication system.

In embodiments, said one or more permissions may comprise permission to view a status message of the first user via the communication system

In embodiments, said one or more permissions may comprise permission to view a geographic location of the first user via the communication system.

In embodiments, said one or more permissions comprise permission to be treated according to a first set of communication preferences set by the first user for the contacts rather a second set of communication preferences set by the second user for non-contacts.

In embodiments, no accept/decline button may be displayed on the user interface of the first terminal in relation to the contact request.

In embodiments, triggered by the receipt of the contact request, a block contact option and/or report as spam option may be included in the conversation area in association with the messaging field.

In embodiments, triggered by the receipt of the contact request, a notification to the first user may be displayed in the conversation area in association with the messaging field, explaining to the first user that he or she can accept the contact request by replying through the messaging field.

In embodiments, the messaging field may enable the first user to send IM messages as at least part of said content of a conversation, and the first user may be enabled to accept the contact request by replying with an IM message entered through the messaging field.

In embodiments, the messaging field may enable the first user to send still images as at least part of said content of a conversation, and the first user may be enabled to accept the contact request by replying with a still image entered through the messaging field.

In embodiments, the messaging field may enable the first user to send video messages as at least part of said content of a conversation, and the first user may be enabled to accept the contact request by replying with a video message entered through the messaging field.

In embodiments, the messaging field may enable the first user to share a geographic location of the first user as at least part of said content of a conversation, and the first user may be enabled to accept the contact request by replying with a shared location of the first user entered through the messaging field.

In embodiments, any reply entered through the messaging field may accept the contact request.

Alternatively, the method may comprise comprising automatically detecting content in the reply by the first user, wherein said automatic acceptance of the contact request may be performed in dependence on the detected content of the reply.

For example, said automatic detection of the content of the reply may comprise automatically detecting whether or not one or more predetermined words or phrases are recognized in the reply, and said automatic acceptance of the contact request may be performed in dependence whether at least one of said one or more predetermined words or phrases are recognized in the reply.

And/or, said automatic detection of the content of the reply may comprise automatically applying natural language processing to the reply to extract a meaning of the reply, and said automatic acceptance of the contact request may be performed in dependence on the extracted meaning.

In embodiments a conversation area may be provided in a user interface on the second terminal, providing a messaging field in which the second user can enter content to be communicated to the first user as part of a two-way conversation conducted via said communication system (after being accepted as a contact); and the contact request may be sent automatically in response to the second user entering a message to the first user through the messaging field on the second user terminal.

Other variants and use cases may become apparent to a person skilled in the art once given the disclosure herein. The scope of the disclosure is not limited by the described embodiments but only by the accompanying claims.

1. A method comprising:
from a first user terminal, a first user accessing a communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system, said one or more permissions not being granted to any of said other users who are not amongst the contacts;
in a conversation area of a user interface on the first terminal, providing a messaging field in which the first user can enter content to be communicated to selected ones of the other users as part of two-way conversations conducted via said communication system;
at the first user terminal, receiving a contact request from a second user of a second user terminal, the second user being one of the other users who is not yet one of the contacts of the first user, and the contact request requesting that the second user becomes one of said contacts; and
automatically accepting the contact request, thereby accepting the second user as one of said contacts of the first user, in response to the user replying to said message through the messaging field.

2. The method of claim 1, wherein the contact request comprises a message from the second user that is displayed in the conversation area in association with said messaging field.

3. The method of claim 1, wherein the number of contact requests the second user can send is limited to a predetermined number of requests.

4. The method of claim 1, wherein said one or more permissions comprise an ability to send IM messages to the first user via the communication system.

5. The method of claim 4, wherein the message in the contact request is limited to a first predetermined length whilst the IM messages are limited to a second predetermined length longer than the first predetermined length, or whilst the IM messages are not limited in length.

6. The method of claim 1, wherein the message sent in the contact request is not allowed to contain media other than text, whilst communications received by the first user terminal via said communication system from the contacts of the first user can contain media other than text.

7. The method of claim 1, wherein said one or more permissions comprise on or both of:
permission to initiate a voice call with the first user via the communication system, and/or
permission to initiate a video call with the first user via the communication system

8. The method of claim 1, wherein said one or more permissions comprise one, some or all of:
permission to view a presence status of the first user via the communication system,
permission to view a status message of the first user via the communication system, and/or
permission to view a geographic location of the first user via the communication system.

9. The method of claim 1, wherein said one or more permissions comprise permission to be treated according to a first set of communication preferences set by the first user for the contacts rather a second set of communication preferences set by the second user for non-contacts.

10. The method of claim 1, wherein no accept/decline button is displayed on the user interface of the first terminal in relation to the contact request.

11. The method of claim 1 wherein, triggered by the receipt of the contact request, a block contact options and/or report as spam option is included in the conversation area in association with the messaging field.

12. The method of claim 1, triggered by the receipt of the contact request, a notification to the first user is displayed in the conversation area in association with the messaging field, explaining to the first user that he or she can accept the contact request by replying through the messaging field.

13. The method of claim 1, wherein the messaging field enables the first user to send IM messages as at least part of said content of a conversation, and the first user can accept the contact request by replying with an IM message entered through the messaging field.

14. The method of claim 1, wherein one, some or all of:
wherein the messaging field enables the first user to send still images as at least part of said content of a conversation, and the first user can accept the contact request by replying with a still image entered through the messaging field;
wherein the messaging field enables the first user to send video messages as at least part of said content of a conversation, and the first user can accept the contact request by replying with a video message entered through the messaging field;
the messaging field enables the first user to share a geographic location of the first user as at least part of said content of a conversation, and the first user can accept the contact request by replying with a shared location of the first user entered through the messaging field.

15. The method of claim 1, wherein any reply entered through the messaging field accepts the contact request.

16. The method of claim 1, comprising automatically detecting content in the reply by the first user, wherein said automatic acceptance of the contact request is performed in dependence on the detected content of the reply.

17. The method of claim 16, wherein said automatic detection of the content of the reply comprises automatically detecting whether or not one or more predetermined words or phrases are recognized in the reply, and said automatic acceptance of the contact request is performed in dependence whether at least one of said one or more predetermined words or phrases are recognized in the reply.

18. The method of claim 17, wherein said automatic detection of the content of the reply comprises automatically applying natural language processing to the reply to extract a meaning of the reply, and said automatic acceptance of the contact request is performed in dependence on the extracted meaning.

19. A computer program product embodied on computer-readable storage and configured so as when run on one or more processors to cause the method of claim 1 to be performed.

20. A communication system comprising a first user terminal and a second user terminal;
wherein the first user terminal is arranged to enable a first user to access the communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system, said one or more permissions not being granted to any of said other users who are not amongst the contacts;
wherein the second user terminal is arranged to enable a second user to access said communication system, the second user being one of said other users;
wherein the first user terminal is arranged so as, in a conversation area of a user interface on the first terminal, to provide a messaging field in which the first user can enter content to be communicated to selected ones of the other users as part of two-way conversations conducted via said communication system;
wherein the second user terminal is arranged so as, in a conversation area of a user interface on the second terminal, to provide a messaging field in which the second user can enter content to be communicated to the first user as part of a two-way conversation conducted via said communication system;
wherein the second user terminal is arranged to enable the second user to send a contact request to the first user terminal, the second user being one of the other users who is not yet one of the contacts of the first user, and the contact request requesting that the second user becomes one of said contacts;
wherein the first user terminal is arranged to receive said contact request;
wherein the communication system is configured so that the contact request is sent automatically in response to the second user entering a message to the first user through the messaging field on the second user terminal; and
wherein the communicating system is configured so that the contact request is automatically accepted, thereby accepting the second user as one of said contacts of the first user, in response to the user replying to said message through the messaging field on the first user terminal.
